(19) United States
(12) Patent Application Publication
(10) Pub. No.: US 2020/0218950 A1
(43) Pub. Date: Jul. 9, 2020

(54) SYSTEMS AND METHODS FOR ASSESSING AND OBTAINING A CALIBRATION FOR A PRINTING DEVICE

(71) Applicant: Global Graphics Software Limited, Cambridge (GB)

(72) Inventor: Daniel Hall, Cambridge (GB)

(21) Appl. No.: 16/242,344

(22) Filed: Jan. 8, 2019

(51) Int. Cl. G06K 15/02; G06F 3/12; G06K 15/00

(52) U.S. Cl. CPC G06K 15/027; G06F 3/1208; G06K 15/002; G06F 3/1256

(57) ABSTRACT

A method of assessing a calibration of a printing device includes obtaining at least one test sample using the printing device; sending a request with user information to a calibration service provider for an analysis of the printing device, where the user information includes the at least one test sample or at least one test image of the at least one test sample; analyzing, by the calibration service provider, the user information and preparing a report including an estimate of improved print quality for a new calibration; and sending the report based on the analysis to the user. The method can also include determining whether to request the new calibration and, if so, requesting, receiving, and installing the new calibration. If not, the report may include one or more remedial actions that can be performed on the printing device.

### FIELD

The invention relates to systems and method for assessing and obtaining a calibration for a printing device, such as a printing press. The invention also relates to systems and method for presenting information for analysis and obtaining an analysis regarding calibration of a printing device, such as a printing press.

### BACKGROUND

Printing presses or other printing devices are periodically re-calibrated and this service can be usefully delivered over the internet without requiring engineer to travel to the printing press location. However, it may be difficult for the user to assess when a new re-calibration would be useful or desirable.

### BRIEF SUMMARY

One embodiment is a method of assessing a calibration of a printing device. The method includes obtaining at least one test sample using the printing device; sending, from a user of the printing device, a request with user information to a calibration service provider for an analysis of the printing device, where the user information includes the at least one test sample or at least one test image of the at least one test sample; analyzing, by the calibration service provider, the user information and preparing a report including an estimate of improved print quality for a new calibration; and sending the report based on the analysis to the user.

In at least some embodiments, the user information further includes a current calibration of the printing device. In at least some embodiments, the method further includes receiving, from the user, a request for the new calibration; generating the new calibration using the user information; sending the new calibration to the user; and installing the new calibration. In at least some embodiments, the report further includes at least one remedial action; where the method further includes performing at least one of the at least one remedial action. In at least some embodiments, the report further includes a simulated image of printing under a new calibration. In at least some embodiments, the report further includes information about a current quality of printing by the printing device. In at least some embodiments, the method further comprises presenting a user interface with thumbnails of previous calibrations for user selection.

Another embodiment is a method of assessing a calibration of a printing device. The method includes receiving, from a user, a request containing user information including at least one test sample or at least one test image of the at least one test sample; analyzing the user information; and sending, to the user, a report based on the analysis of the user information including an estimate of improved print quality for a new calibration.

In at least some embodiments, the user information further includes a current calibration of the printing device. In at least some embodiments, further includes receiving, from the user, a request for the new calibration; generating the new calibration using the test image and current calibration; and sending the new calibration to the user. In at least some embodiments, the report further includes at least one remedial action for the printing device. In at least some embodiments, the report further includes a simulated image of printing under a new calibration. In at least some embodiments, the report further includes information about a current quality of printing by the printing device. In at least some embodiments, the method further comprises presenting a user interface with thumbnails of previous calibrations for user selection.

A further embodiment is a system for assessing a calibration of a printing device that includes a processor configured and arranged to perform any of the methods described above.

Yet another embodiment is a method of assessing a calibration of a printing device. The method includes obtaining at least one test sample using the printing device; sending, to a calibration service provider, a request with user information for an analysis of the printing device, where the user information includes the at least one test sample or at least one test image of the at least one test sample; and receiving, from the calibration service provider, a report based on the analysis of the user information including an estimate of improved print quality for a new calibration.

In at least some embodiments, the user information further includes a current calibration of the printing device. In at least some embodiments, the method further includes sending, to the calibration service provider, a request for the new calibration; receiving, from the calibration service provider, the new calibration; and installing the new calibration on the printing device. In at least some embodiments, the report further includes at least one remedial action; wherein the method further includes performing at least one of the at least one remedial action. In at least some embodiments, the report further includes a simulated image of printing under a new calibration. In at least some embodiments, the report further includes information about a current quality of printing by the printing device. In at least some embodiments, the method further comprises presenting a user interface with thumbnails of previous calibrations for user selection.

A further embodiment is a system for assessing a calibration of a printing device that includes a processor configured and arranged to perform any of the methods described above.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic representation of one embodiment of an environment in which the invention can be employed;

FIG. 2 is a schematic representation of one embodiment of a computing or printing device;

FIG. 3A is flowchart of one embodiment of a method of assessing a calibration of a printing device;

FIG. 3B is flowchart of a second embodiment of a method of assessing a calibration of a printing device;

FIG. 4A is flowchart of a third embodiment of a method of assessing a calibration of a printing device;

FIG. 4B is flowchart of a third embodiment of a method of assessing a calibration of a printing device;

FIG. 5 is flowchart of a further embodiment of a method of assessing a calibration of a printing device;

FIG. 6 is a diagram of one embodiment of a user interface for requesting a calibration analysis or new calibration; and

FIG. 7 is a diagram of one embodiment of a user interface for investigating previous calibrations.

### DETAILED DESCRIPTION

The invention relates to systems and method for assessing and obtaining a calibration for a printing device, such as a printing press. The invention also relates to systems and method for presenting information for analysis and obtaining an analysis regarding calibration of a printing device, such as a printing press.

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The following detailed description is, therefore, not to be taken in a limiting sense. The methods described herein can be performed using any type of processor and any suitable type of device that includes a processor.

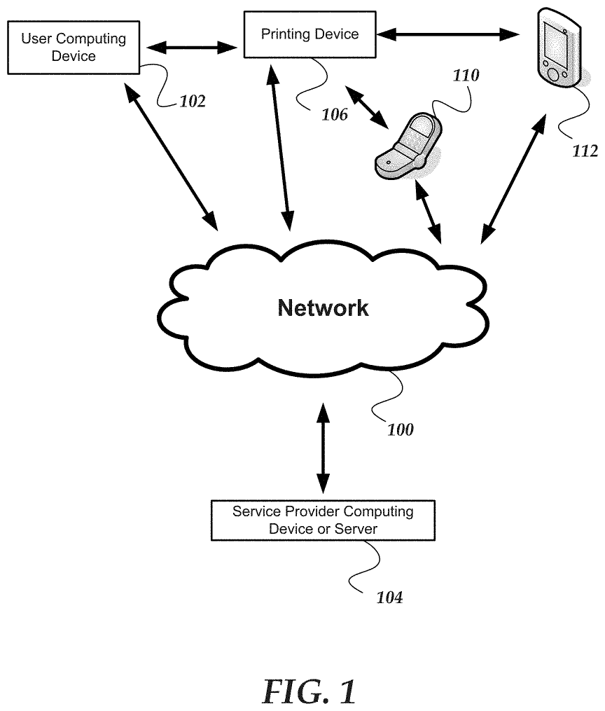

FIG. 1 illustrates one embodiment of a network environment. It will be understood that the network environment can be a local area network, a wide area network, or any combination thereof. It will also be understood that the network can include devices, other than those illustrated, coupled to the network and that there may be multiple devices of each type illustrated connected to the network. The environment includes a network 100 to which is attached, either directly or through other devices, one or more computing devices 102 (e.g., computers, workstations, servers, or the like) of a user, one or more computing devices or servers 104 of a service provider, optionally, one or more printing devices (such as a printing press, printer, or the like) 106, or any combination of these devices. Other devices can optionally be attached to the network such as cellular telephones 110, personal data assistants (PDA's) or tablets 112, portable storage devices (not shown) such as, e.g., compact discs, DVDs, memory sticks, flash drives, or other optical or magnetic storage media, and the like. Any of these devices can be connected directly to the network or via another device such as a computing device/server 102, 104. Methods of communication can include both wired and wireless (e.g., RF, optical, Wi-Fi, Bluetooth™, or infrared or the like) communications methods and such methods provide another type of computer readable media; namely communication media.

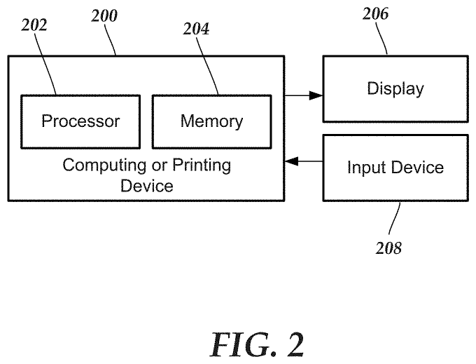

FIG. 2 illustrates one embodiment of a computing or printing device 200. The computing or printing device 200 includes a processor 202 and a memory 204 and can be attached to one or more of a display 206 and an input device 208.

The computing or printing device 200 can be a laptop computer, desktop computer, printing press, printer, tablet, mobile device, smartphone or any other device that can run applications or programs, or any other suitable device for processing information and for presenting a user interface. The computing or printing device 200 can be entirely local to the user or can include components that are non-local to the user including one or both of the processor 202 or memory 204 (or portions thereof). For example, in some embodiments, the user may operate a terminal that is connected to a non-local computer. In some embodiments, the memory can be non-local to the user.

The computing or printing device 200 can utilize any suitable processor 202 including one or more hardware processors that may be local to the user or non-local to the user or other components of the computer. The processor 202 is configured to execute instructions provided to the processor.

Any suitable memory 204 can be used for the computing or printing device 200. The memory 204 illustrates a type of computer-readable media, namely computer-readable storage media. Computer-readable storage media may include, but is not limited to, nonvolatile, non-transitory, removable, and non-removable media implemented in any method or technology for storage of information, such as computer readable instructions, data structures, program modules, or other data. Examples of computer-readable storage media include RAM, ROM, EEPROM, flash memory, or other memory technology, CD-ROM, digital versatile disks (“DVD”) or other optical storage, magnetic cassettes, magnetic tape, magnetic disk storage or other magnetic storage devices, or any other medium which can be used to store the desired information and which can be accessed by a computer.

Communication methods provide another type of computer readable media; namely communication media. Communication media typically embodies computer-readable instructions, data structures, program modules, or other data in a modulated data signal such as a carrier wave, data signal, or other transport mechanism and include any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

The display 206 can be any suitable display device, such as a monitor, screen, display, or the like. The input device 208 can be, for example, a keyboard, mouse, touch screen, track ball, joystick, voice recognition system, or any combination thereof, or the like and can be used by the user to interact with a user interface.

Methods and systems can facilitate the analysis of a current printing press configuration or calibration, as well as the determination of whether a new calibration of the printing press is desirable, useful, or necessary. A user can request an analysis by a calibration service provider (such as an online calibration service provider). Upon receiving the analysis, the user can determine whether a new calibration is desirable, useful, or necessary. In at least some embodiments, the analysis may also indicate whether remedial actions (for example, maintenance) on the printing press is desirable, useful, or necessary. A printing press will be used as an example below, but it will be understood that the methods and systems can be used for analyzing and calibrating other printing devices.

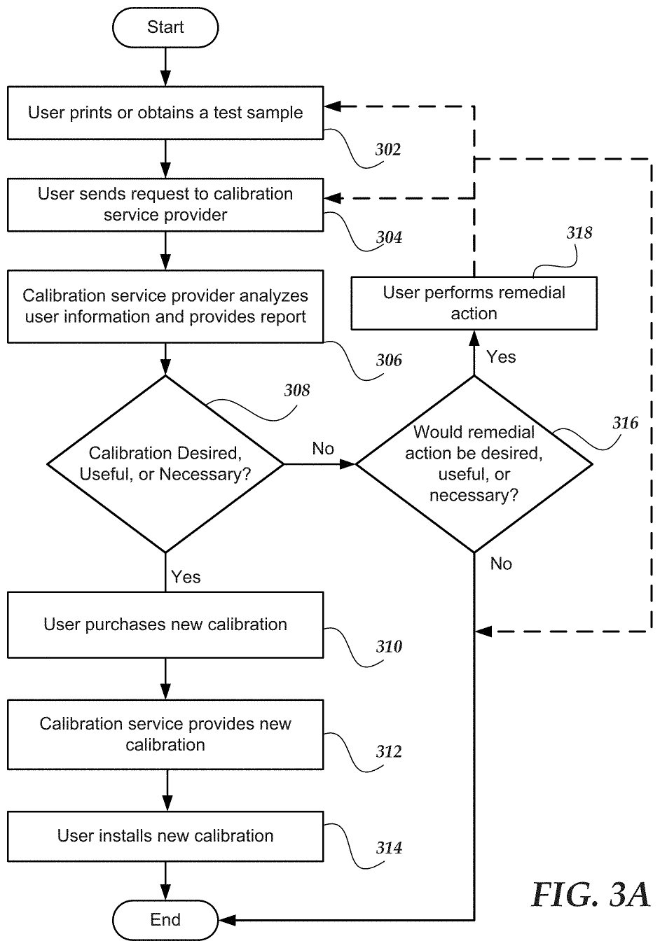

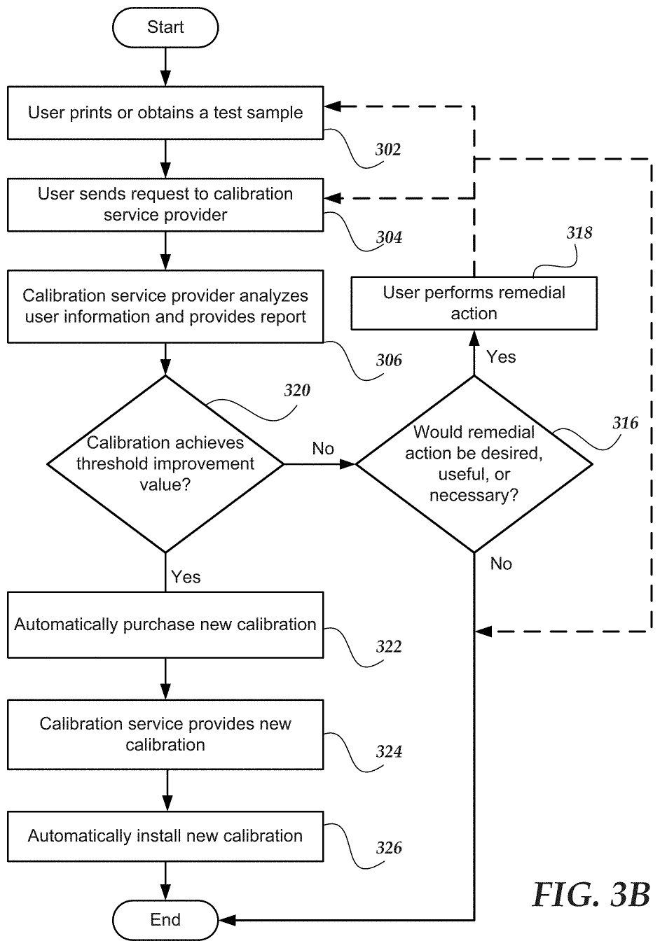

FIG. 3A illustrates one embodiment of a method of analyzing a printing device or providing a calibration for a printing device, such as a printing press. In step 302, the user (for example, an operator or owner) of a printing press prints, or otherwise obtains, one or more test samples (for example, test pages or test images). Alternatively, previously printed test samples can be used. The test sample can be, for example, an uncalibrated test sample or a test sample printed using the current calibration or the printing device or any combination thereof. In at least some embodiments, the user can scan the one or more test samples and create one or more test images of the one or more test samples for transfer to the service provider.

In step 304, the user sends a request for an analysis to a calibration service provided. The user typically also supplies information, such as the one or more test images or test sample, to the calibration service provider, such as an internet-based (online) printing press calibration service provider. The information supplied can include one or more of the following in any combination: 1) scanned image data of an actual un-calibrated test sample or calibrated test sample from the printing press; 2) a current calibration for the printing press or a reference to the current calibration stored by the calibration service provider, or 3) optionally, a new test image of a test sample or a reference to a test image previously uploaded; or 4) any other suitable information (make and model of the printing device; maintenance history of the printing device, information regarding the operational history of the printing device (such as number of print jobs or pages or the like) to facilitate an analysis of the printing device. As an example, the user can provide scanned test samples and current calibration data to the service provider (and, optionally, an image for simulated printing). The user may purchase the analysis (with an accompanying report on this data) from the service provider.

In step 306, the service provider analyzes the information sent by the user and provides a report on the analysis of the information. For example, the service provider can provide one or more of the following: data on the current performance of the printing press; a simulated improvement that would be expected from replacing the current calibration with a newly generated calibration; or any combination thereof. As further examples, the report of the analysis from the service provider can include one or more of the following in any combination: 1) information about the current quality of the printing press (such as, for example the maximum density variance across the printing nozzles of the printing press in the case of an inkjet printing press which may optionally include information about the quality of specific inkjet printheads on the printing press); 2) information about how the quality of the printing would be expected to improve if a new calibration was based on the test samples and used on the printing press as compared with continued use of the current calibration; 3) simulated images of what printing with the current and new calibrations on the printing press would look like (potentially providing a sales tool for the press operator to evaluate the cost-benefit for the end user who is buying the prints); 4) a recommendation about possible remedial actions (for example, maintenance) that could or should be performed (such as, for example, which printheads on the printing press may be beneficially maintained, cleaned, or replaced); or 5) a recommendation about the benefit of generating and using a new calibration on the printing press. In at least some embodiments, the service provider can deliver simulated images that the user can use to evaluate the benefit of a new calibration in the context of a particular printing job, or which the user can supply to their customer to give the customer an understanding of the benefits of recalibrating the printing press for a specific printing job

In step 308, the user makes a decision about whether a new calibration is desired, useful, or necessary based, at least in part, on the report of the analysis supplied by the service provider. If the user decides to pursue the new calibration, in step 310, the user sends a request to purchase the new calibration. In step 312, the service provider sends the new calibration. In at least some embodiments, the service provider may generate the new calibration upon receiving the request from step 310 or may have already generated the new calibration with the analysis in step 306. In step 314, the user installs the new calibration.

If the user decides not to obtain a new calibration in step 308, optionally, the user may consider in step 316 whether remedial action (for example, maintenance) on the printing press would be desired, useful, or necessary based on the analysis supplied by the service provider. Examples of remedial action that can be performed include, but are not limited to, cleaning or maintaining one or more of the press printheads or other components of the printing press; replacing one or more printheads or other components of the printing press, performing general or specific maintenance on the printing press or components of the printing press, or the like or any combination thereof. In step 318, the user performs the remedial action. The user may decide, after performing the remedial action, to start the process again at step 302 or 304. In other instances, the user may simply decide that the remedial action is sufficient and end the process. These options are indicated by dashed lines in FIG. 3A. In yet other instances, instead of performing a remedial action such as maintenance, the user may choose to do nothing or may postpone obtaining a new calibration.

In at least some embodiments, a user might pay one lower fee for the analysis in step 306 and a higher fee to generate and deploy a new calibration onto the target printing press in steps 310 to 314. It can be valuable for the user to have the opportunity to take any remedial actions (for example, cleaning, repair, parts replacement, or the like) before committing to purchasing a new printing press calibration. Differential pricing between testing and generating a new printing press calibration can be advantageous, so that the user has the option to take remedial action before committing to purchasing the new calibration.

In at least some embodiments, a user might pay one lower fee for the analysis in step 306 and a higher fee to generate and deploy a new calibration onto the target printing press in steps 310 to 314. It can be valuable for the user to have the opportunity to take any remedial actions (for example, cleaning, repair, parts replacement, or the like) before committing to purchasing a new printing press calibration. Differential pricing between testing and generating a new printing press calibration can be advantageous, so that the user has the option to take remedial action before committing to purchasing the new calibration.

FIG. 3B illustrates another embodiment of a method of analyzing a printing device or providing a calibration for a printing device, such as a printing press. Steps 302, 304, 306, 316, and 318 are the same as described above with respect to FIG. 3A.

In step 320, the system of either the user or the service provider determines whether the new calibration proposed by the service provider meets a threshold improvement value. This threshold improvement value can be predefined by the user or the service provider. The threshold improvement value may be based on any suitable improvement criteria. As an example, if the standard deviation of the compensation applied at all locations between the new calibration and a previous, or other, calibration is greater than a threshold value. As other examples, the threshold improvement values may utilize one or more metrics that reflect the perceptual significance of the density shifts due to a new calibration compared with a previous, or other, calibration.

If the system determines that the threshold improvement value is achieved in step 322, the system can automatically purchase the new calibration. Alternatively, the system may present a recommendation to the user to purchase the new calibration and the user may then decide whether to purchase the new calibration or not. In step 324, the service provider sends the new calibration. In step 326, the user's system (e.g., the printing press or other printing device or a computer coupled to the printing press or other printing device) or service provider's system automatically installs the new calibration. Alternatively, the system may alert the user that the new calibration is available and the user can direct installation of the new calibration.

In this embodiments, the new calibration is purchased and installed on the printing press or other printing device automatically without requiring human evaluation or authorization at the point when a new calibration is required. This would facilitate, for example, constant operation of a printing press or other printing device even when a skilled operator was not available to manage new calibrations. These automatic decisions could then be recorded by the computer to be reviewed or authorized by a human operator at a more convenient time.

In at least some embodiments, a method or system can take as input both existing printing press calibration data and scans of test images. The online service provider can then analyze whether a new calibration would be required or beneficial and provide information on the likely improvement to the user. The user can then determine whether it is economically useful to purchase a new calibration. Optionally, the on-line system can simulate the effect of the new and old calibration on a standard or user-supplied test image so that an unskilled user and/or the user's customer can determine easily if the value generated from purchasing a new calibration may be worth the cost.

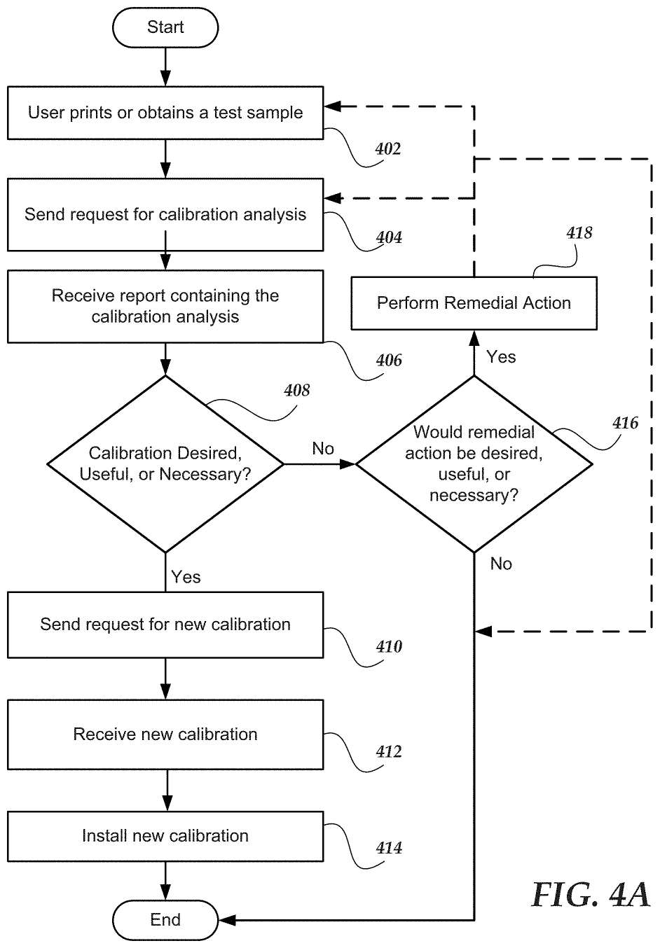

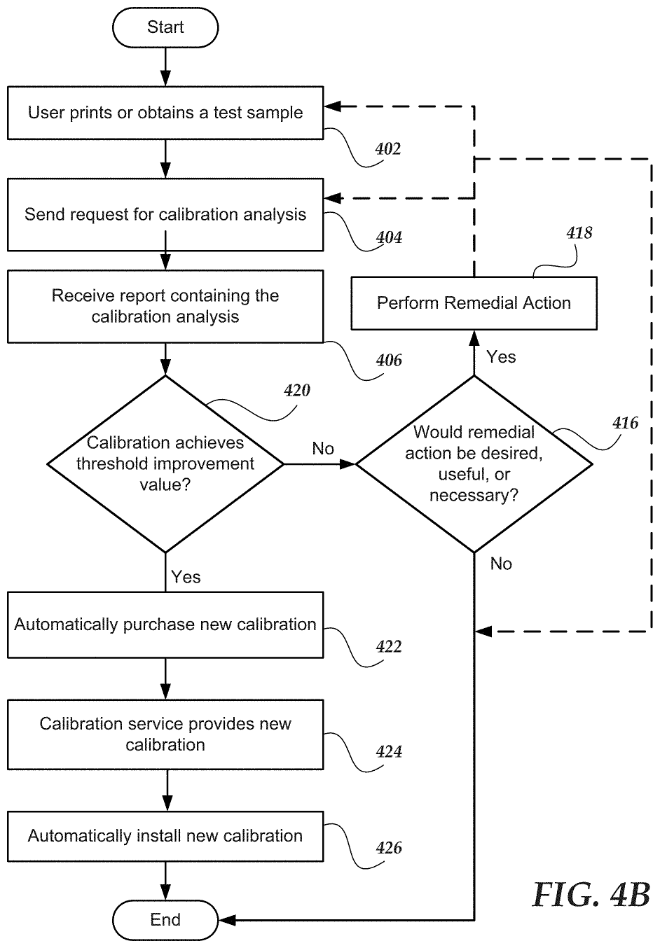

FIG. 4A illustrates a method or steps that can be performed, at least in part, by a processor for the user. In step 402, the user (for example, an operator or owner) of a printing press prints, or otherwise obtains, one or more test samples (for example, test pages or test images). Alternatively, previously printed test samples can be used. The test sample can be, for example, an uncalibrated test sample or a test sample printed using the current calibration or the printing device or any combination thereof. In at least some embodiments, the user can scan the one or more test samples and create one or more test images of the one or more test samples for transfer to the service provider.

In step 404, the user sends a request for a calibration analysis to a calibration service provided. The user typically also supplies information, such as the one or more test images or test sample, to the calibration service provider, such as an internee-based (online) printing press calibration service provider. The information supplied can include one or more of the following in any combination: 1) scanned image data of an actual un-calibrated test sample or calibrated test sample from the printing press; 2) a current calibration for the printing press or a reference to the current calibration stored by the calibration service provider, or 3) optionally, a new test image of a test sample or a reference to a test image previously uploaded; or 4) any other suitable information (make and model of the printing device; maintenance history of the printing device, information regarding the operational history of the printing device (such as number of print jobs or pages or the like) to facilitate an analysis of the printing device. As an example, the user can provide scanned test samples and current calibration data to the service provider (and, optionally, an image for simulated printing). The user may purchase the analysis (with an accompanying report on this data) from the service provider.

In step 406, the receives a report containing the calibration analysis. For example, the report can include one or more of the following: data on the current performance of the printing press; a simulated improvement that would be expected from replacing the current calibration with a newly generated calibration; or any combination thereof. As further examples, the report of the analysis from the service provider can include one or more of the following in any combination: 1) information about the current quality of the printing press (such as, for example the maximum density variance across the printing nozzles of the printing press in the case of an inkjet printing press which may optionally include information about the quality of specific inkjet printheads on the printing press); 2) information about how the quality of the printing would be expected to improve if a new calibration was based on the test samples and used on the printing press as compared with continued use of the current calibration; 3) simulated images of what printing with the current and new calibrations on the printing press would look like (potentially providing a sales tool for the press operator to evaluate the cost-benefit for the end user who is buying the prints); 4) a recommendation about possible remedial actions (for example, maintenance) that could or should be performed (such as, for example, which printheads on the printing press may be beneficially maintained, cleaned, or replaced); or 5) a recommendation about the benefit of generating and using a new calibration on the printing press. In at least some embodiments, the report can include simulated images that the user can use to evaluate the benefit of a new calibration in the context of a particular printing job, or which the user can supply to their customer to give the customer an understanding of the benefits of recalibrating the printing press for a specific printing job

In step 408, the user makes a decision about whether a new calibration is desired, useful, or necessary based, at least in part, on the report of the analysis supplied by the service provider. If the user decides to pursue the new calibration, in step 410, the user sends a request to purchase the new calibration. In step 412, the user receives the new calibration. In step 414, the user installs the new calibration.

If the user decides not to obtain a new calibration in step 408, optionally, the user may consider in step 416 whether remedial action (for example, maintenance) on the printing press would be desired, useful, or necessary based on the analysis supplied by the service provider. Examples of remedial action that can be performed include, but are not limited to, cleaning or maintaining one or more of the press printheads or other components of the printing press; replacing one or more printheads or other components of the printing press, performing general or specific maintenance on the printing press or components of the printing press, or the like or any combination thereof. In step 418, the user performs the remedial action. The user may decide, after performing the remedial action, to start the process again at step 402 or 404. In other instances, the user may simply decide that the remedial action is sufficient and end the process. These options are indicated by dashed lines in FIG. 4A. In yet other instances, instead of performing a remedial action such as maintenance, the user may choose to do nothing or may postpone obtaining a new calibration.

FIG. 4B illustrates another embodiment of a method of analyzing a printing device or providing a calibration for a printing device, such as a printing press. Steps 402, 404, 406, 416, and 418 are the same as described above with respect to FIG. 4A.

In step 420, the system of either the user or the service provider determines whether the new calibration proposed by the service provider meets a threshold improvement value. This threshold improvement value can be predefined by the user or the service provider. The threshold improvement value may be based on any suitable improvement criteria. As an example, if the standard deviation of the compensation applied at all locations between the new calibration and a previous, or other, calibration is greater than a threshold value. As other examples, the threshold improvement values may utilize one or more metrics that reflect the perceptual significance of the density shifts due to a new calibration compared with a previous, or other, calibration.

If the system determines that the threshold improvement value is achieved in step 422, the system can automatically purchase the new calibration. Alternatively, the system may present a recommendation to the user to purchase the new calibration and the user may then decide whether to purchase the new calibration or not. In step 424, the service provider sends the new calibration. In step 426, the user's system (e.g., the printing press or other printing device or a computer coupled to the printing press or other printing device) or service provider's system automatically installs the new calibration. Alternatively, the system may alert the user that the new calibration is available and the user can direct installation of the new calibration.

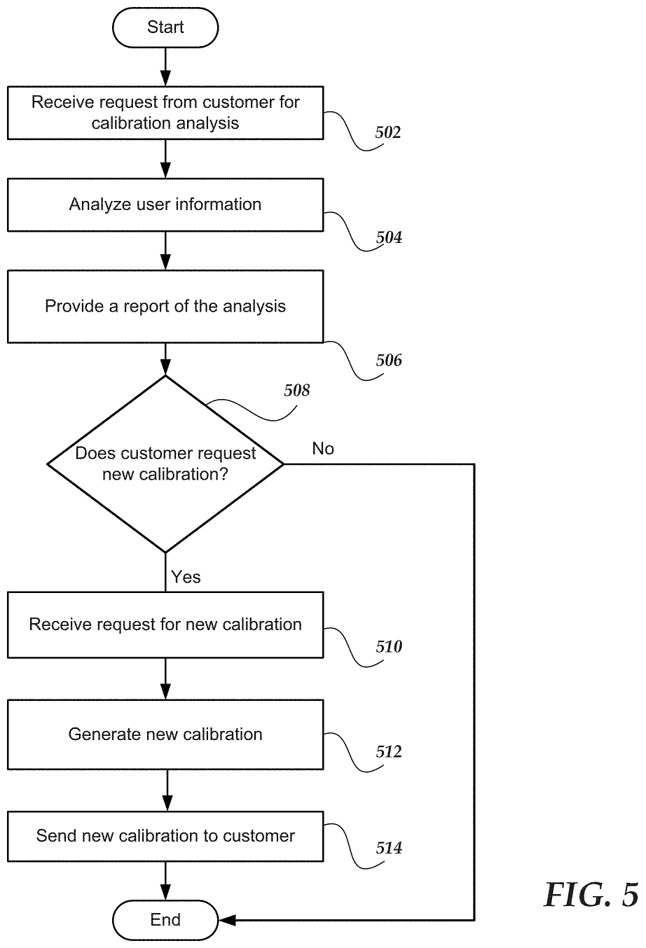

FIG. 5 illustrates a method or steps that can be performed, at least in part, by a processor for a calibration service provider. In step 502, the service provider receives a request from a user of a printing device, such as a printing press, for a calibration analysis. The user typically also supplies information, such as the one or more test images or test sample, to the calibration service provider, such as an internet-based (online) printing press calibration service provider. The information supplied can include one or more of the following in any combination: 1) scanned image data of an actual un-calibrated test sample or calibrated test sample from the printing press; 2) a current calibration for the printing press or a reference to the current calibration stored by the calibration service provider, or 3) optionally, a new test image of a test sample or a reference to a test image previously uploaded; or 4) any other suitable information (make and model of the printing device; maintenance history of the printing device, information regarding the operational history of the printing device (such as number of print jobs or pages or the like) to facilitate an analysis of the printing device. As an example, the user can provide scanned test samples and current calibration data to the service provider (and, optionally, an image for simulated printing). The user may purchase the analysis (with an accompanying report on this data) from the service provider.

In step 504, the service provider analyzes the information sent by the user and, in step 506, provides a report on the analysis of the information. For example, the service provider can provide one or more of the following: data on the current performance of the printing press; a simulated improvement that would be expected from replacing the current calibration with a newly generated calibration; or any combination thereof. As further examples, the report of the analysis from the service provider can include one or more of the following in any combination: 1) information about the current quality of the printing press (such as, for example the maximum density variance across the printing nozzles of the printing press in the case of an inkjet printing press which may optionally include information about the quality of specific inkjet printheads on the printing press); 2) information about how the quality of the printing would be expected to improve if a new calibration was based on the test samples and used on the printing press as compared with continued use of the current calibration; 3) simulated images of what printing with the current and new calibrations on the printing press would look like (potentially providing a sales tool for the press operator to evaluate the cost-benefit for the end user who is buying the prints); 4) a recommendation about possible remedial actions (for example, maintenance) that could or should be performed (such as, for example, which printheads on the printing press may be beneficially maintained, cleaned, or replaced); or 5) a recommendation about the benefit of generating and using a new calibration on the printing press. In at least some embodiments, the service provider can deliver simulated images that the user can use to evaluate the benefit of a new calibration in the context of a particular printing job, or which the user can supply to their customer to give the customer an understanding of the benefits of recalibrating the printing press for a specific printing job

In step 508, the service provide awaits a decision by the user to request a new calibration. If the user decides to pursue the new calibration, in step 510, the service provide receives a request to purchase the new calibration. In step 512, the service provider generates the new calibration. In at least some embodiments, the service provider may generate the new calibration upon receiving the request from step 510 or may have already generated the new calibration with the analysis in step 504. In step 514, the service provider sends the new calibration to the user. If the user decides not to obtain a new calibration in step 508, the process ends.

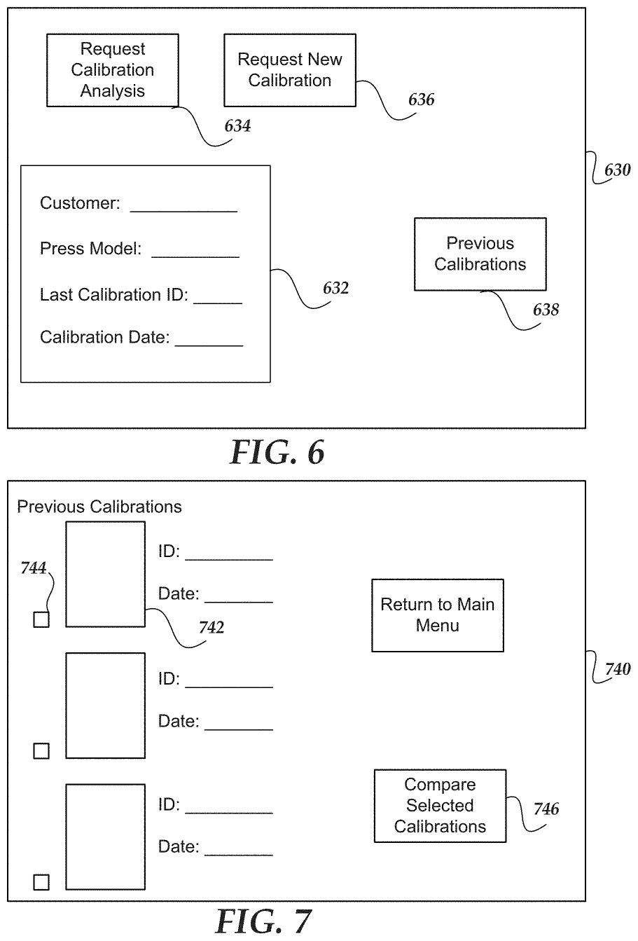

FIG. 6 illustrates one embodiment of a user interface 630. It will be recognized that other user interfaces may include more or fewer features. The user interface 630 of FIG. 6 includes an identification region 632 where information such as customer name or number, printing press (or printer) model or other identification information, last calibration identification (in any), and last calibration date can be presented. Any other relevant information may be included. In at least some embodiments, the user interface 630 may also allow entry or modification of this information by a customer. In some embodiments, a calibration can be given a unique identifier or name.

The user interface 630 also includes a button 634 or other arrangement for the customer to request a calibration analysis as described above and a button 636 or other arrangement for a customer to request a new calibration as described above. In some embodiments, button 636 may only be available after the calibration analysis has been performed. The user interface 630 also includes a button 638 for investigating previous calibrations, if any.

FIG. 7 illustrates a user interface 740 for investigating previous calibrations (which may also include the current calibration). It will be recognized that this user interface may be combined with user interface 630 in a single user interlace. It will be reorganized that other user interfaces may include more or fewer features.

The user interface 740 includes thumbnails 742 of previous calibrations and identifying information such as a calibration identifier or id and a calibration date. Optionally, this list of thumbnails 742 may also include calibrations that were not, or have not, been purchased.

In some embodiments, selecting (or double selecting) a thumbnail 742 (or selecting a tick box 744 associated with the thumbnail 742) may provide an expanded view of the thumbnail. The thumbnail may provide, for example, a density map showing relative areas of density gain/loss across the printing press or other printing device due to that calibration. Other measures or visualizations of the calibration may be used instead.

In some embodiments, the user interface 740 includes a button 746 that produces a visual or quantitative comparison between all of the previous calibrations or between two or more calibrations that have been selected by the customer or other user.

In some embodiments, comparison may be a density map of differences between two selected calibrations. Such a comparison can be useful for a variety of purposes including, but not limited to, interactively exploring changes over time to the printing press or other printing device represented by the changes in calibrations over time.

It will be understood that each block of the flowchart illustration, and combinations of blocks in the flowchart illustration and methods disclosed herein, can be implemented by computer program instructions. These program instructions may be provided to a processor to produce a machine, such that the instructions, which execute on the processor, create means for implementing the actions specified in the flowchart block or blocks disclosed herein. The computer program instructions may be executed by a processor to cause a series of operational steps to be performed by the processor to produce a computer implemented process. The computer program instructions may also cause at least some of the operational steps to be performed in parallel. Moreover, some of the steps may also be performed across more than one processor, such as might arise in a multi-processor computer system. In addition, one or more processes may also be performed concurrently with other processes, or even in a different sequence than illustrated without departing from the scope or spirit of the invention.

The computer program instructions can be stored on any suitable computer-readable medium including, but not limited to, RAM, ROM, EEPROM, flash memory or other memory technology, CD-ROM, digital versatile disks (“DVD”) or other optical storage, magnetic cassettes, magnetic tape, magnetic disk storage or other magnetic storage devices, or any other medium which can be used to store the desired information and which can be accessed by a computer.

The above specification and examples provide a description of the invention. Since many embodiments of the invention can be made without departing from the spirit and scope of the invention, the invention also resides in the claims hereinafter appended.

1. A method of assessing a calibration of a printing device, the method comprising:
obtaining at least one test sample using the printing device;
sending, from a user of the printing device, a request with user information to an external calibration service provider for an analysis of the printing device, wherein the user information comprises i) current calibration data for the current calibration of the printing device and ii) the at least one test sample or at least one test image of the at least one test sample;
analyzing, by the external calibration service provider, the user information and preparing a report including an estimate of improved print quality for a new calibration; and
sending the report based on the analysis to the user.

2. (canceled)

3. The method of claim 1, further comprising
receiving, from the user, a request for the new calibration;
generating the new calibration using the user information;
sending the new calibration to the user; and
installing the new calibration.

4. The method of claim 1, wherein the report further comprises at least one remedial action, wherein the method further comprises performing at least one of the at least one remedial action.

5. The method of claim 1, wherein the report further comprises a simulated image of printing under a new calibration.

6. The method of claim 1, further comprising presenting a user interface with thumbnails of previous calibrations for user selection.

7. A method of assessing a calibration of a printing device, the method comprising:
receiving, from a user, a request containing user information comprising i) current calibration data for the current calibration of the printing device and ii) at least one test sample or at least one test image of the at least one test sample;
analyzing the user information; and
sending, to the user, a report based on the analysis of the user information including an estimate of improved print quality for a new calibration.

8. (canceled)

9. The method of claim 7, further comprising
receiving, from the user, a request for the new calibration;
generating the new calibration using the test image and current calibration; and
sending the new calibration to the user.

10. The method of claim 7, wherein the report further comprises at least one remedial action for the printing device.

11. The method of claim 7, wherein the report further comprises a simulated image of printing under a new calibration.

12. The method of claim 7, further comprising presenting a user interface with thumbnails of previous calibrations for user selection.

13. A system for assessing a calibration of a printing device, the system comprising
a processor configured and arranged to perform the method of claim 7.

14. A method of assessing a calibration of a printing device, the method comprising:
obtaining at least one test sample using the printing device;
sending, to an external calibration service provider, a request with user information for an analysis of the printing device, wherein the user information comprises i) current calibration data for the current calibration of the printing device and ii) the at least one test sample or at least one test image of the at least one test sample; and
receiving, from the external calibration service provider, a report based on the analysis of the user information including an estimate of improved print quality for a new calibration.

15. (canceled)

16. The method of claim 14, further comprising
sending, to the external calibration service provider, a request for the new calibration;
receiving, from the external calibration service provider, the new calibration; and
installing the new calibration on the printing device.

17. The method of claim 14, wherein the report further comprises at least one remedial action; wherein the method further comprises performing at least one of the at least one remedial action.

18. The method of claim 14, wherein the report further comprises a simulated image of printing under a new calibration.

19. The method of claim 14, wherein the report further comprises information about a current quality of printing by the printing device.

20. A system for assessing a calibration of a printing device, the system comprising
a processor configured and arranged to perform the method of claim 14.

21. The method of claim 1, wherein the report further comprises at least one remedial action, wherein the method further comprises selecting, by the user, whether to perform at least one of the at least one remedial action or to request a new calibration.

22. The method of claim 14, wherein the report further comprises at least one remedial action, wherein the method further comprises selecting, by the user, whether to perform at least one of the at least one remedial action or to request a new calibration.

23. The method of claim 1, wherein the external calibration service provider is remote from the user and the printing device.
